(19) United States
(12) Patent Application Publication
(10) Pub. No.: US 2024/0085918 A1
(43) Pub. Date: Mar. 14, 2024

(54) WORK PLAN CREATION APPARATUS AND WORK PLAN CREATION METHOD

(71) Applicant: Mitsubishi Electric Corporation, Tokyo (JP)

(72) Inventors: Masayuki IHARA, Tokyo (JP); Shingo KOBORI, Tokyo (JP); Hiroshi TAGUCHI, Tokyo (JP)

(73) Assignee: Mitsubishi Electric Corporation, Tokyo (JP)

(21) Appl. No.: 18/272,797

(22) PCT Filed: Feb. 2, 2021
(86) PCT No.: PCT/JP2021/003627

§ 371 Date: Jul. 18, 2023

(51) Int. Cl. G05D 1/02

(52) U.S. Cl. CPC G05D 1/0217; G05D 1/0225; G05B 2219/50391

(57) ABSTRACT

An object of the present disclosure is to provide a work plan creation apparatus capable of making an autonomous moving body perform a work without delay when the work needs to be adjusted and a work plan creation method. A work plan creation apparatus according to the present disclosure includes: an action planning unit previously creating a work plan in which a work to be performed by at least one autonomous moving body is allocated in a predetermined period; a plan change determination unit evaluating a degree of priority of a new work, which is a work newly occurring, upon receiving the new work, and determining whether or not to change the work plan in accordance with the degree of priority while the autonomous moving body performs the work plan; and a plan change unit changing the work plan while the autonomous moving body performs the work plan.

### TECHNICAL FIELD

The present disclosure relates to a work plan creation apparatus and a work plan creation method creating a work plan of an autonomous moving body.

### BACKGROUND ART

Promoted recently is introduction of a service robot performing an operation such as cleaning or security in an office building and a station in accordance with reduction of a working population, for example. Such a robot is operated by an administrator previously or appropriately setting a plan and an operation. When the administrator manually performs setting, a work needs to be allocated one by one in consideration of performance of a robot, a timing of charging a robot, and a limitation of not interfering with behaviors of persons located indoors such as inside an office building, for example. When the work increases or is diversified, creation of a plan is complicated, thus it is difficult to efficiently create a plan, and this may lead to an excess investment such as securing of robots more than necessary.

Disclosed conventionally is a technique of determining necessity of charging from a remaining amount of charge of a robot, and replanning a work in accordance with determination that charging is necessary (for example, Patent Document 1). Also disclosed is a technique of adjusting a work between autonomous moving bodies or between an autonomous moving body and a person when a work of a certain autonomous moving body needs to be adjusted (refer to Patent Document 2, for example). The state where the work needs to be adjusted in Patent Document 2 includes a state where a work which cannot be executed by an autonomous moving body occurs, such as a state where works are overlapped with each other in a schedule, and a state where there is a possibility that an autonomous moving body collides with the other autonomous moving body or a person when the autonomous moving body is moved.

### PRIOR ART DOCUMENTS

### Patent Document(s)

Patent Document 1: Japanese Patent Application Laid-Open No. 2006-106919
Patent Document 2: Japanese Patent Application Laid-Open No. 2018-5799

### SUMMARY

### Problem to be Solved by the Invention

In Patent Document 1, plans of all of robots need to be created again from the beginning when the work is replanned. In Patent Document 2, when the work is adjusted, an autonomous moving body whose work needs to be adjusted needs to share the work with the other autonomous moving body or needs to adjust a movement with the other autonomous moving body. In this manner, there is a possibility that the work of the autonomous moving body is suspended when the work needs to be adjusted.

The present disclosure is to solve the above problems, and an object of the present disclosure is to provide a work plan creation apparatus and a work plan creation method capable of making an autonomous moving body perform a work without delay when the work needs to be adjusted.

### Means to Solve the Problem

In order to solve the above problems, a work plan creation apparatus according to the present disclosure includes: an action planning unit previously creating a work plan in which a work to be performed by at least one autonomous moving body is allocated in a predetermined period; a plan change determination unit evaluating a degree of priority of a new work, which is a work newly occurring, upon receiving the new work, and determining whether or not to change the work plan in accordance with the degree of priority while the autonomous moving body performs the work plan; and a plan changing unit changing the work plan while the autonomous moving body performs the work plan.

### Effects of the Invention

According to the present disclosure, an autonomous moving body can be made to perform a work without delay when the work needs to be adjusted.

These and other objects, features, aspects and advantages of the present disclosure will become more apparent from the following detailed description when taken in conjunction with the accompanying drawings.

### BRIEF DESCRIPTION OF DRAWINGS

FIG. 1 A configuration diagram of an autonomous moving body system to which a work plan creation apparatus according to an embodiment 1 is applied.

FIG. 2 A diagram for explaining a work database according to the embodiment 1.

FIG. 3 A diagram for explaining an autonomous moving body database according to the embodiment 1.

FIG. 4 A diagram for explaining a charger database according to the embodiment 1.

FIG. 5 A diagram for explaining a work plan of an autonomous moving body according to the embodiment 1.

FIG. 6 A flow chart illustrating an operation of the work plan creation apparatus according to the embodiment 1.

FIG. 7 A flow chart illustrating an operation of the work plan creation apparatus according to the embodiment 1.

FIG. 8 A diagram for explaining a plan changing range of the work plan according to the embodiment 1.

FIG. 9 A configuration diagram of an autonomous moving body system to which a work plan creation apparatus according to an embodiment 2 is applied.

FIG. 10 A diagram for explaining a work plan of an autonomous moving body according to the embodiment 2.

FIG. 11 A diagram for explaining a relief work according to the embodiment 2.

FIG. 12 A configuration diagram of an autonomous moving body system to which a work plan creation apparatus according to an embodiment 3 is applied.

FIG. 13 A diagram for explaining a strongly possible work according to the embodiment 3.

FIG. 14 A diagram for explaining a work plan of an autonomous moving body according to the embodiment 3.

FIG. 15 A diagram for explaining a work plan of the autonomous moving body according to the embodiment 3.

FIG. 16 A flow chart illustrating an operation of the work plan creation apparatus according to the embodiment 3.

FIG. 17 A diagram illustrating an example of a hardware configuration of the work plan creation apparatus according to the embodiments 1 to 3.

FIG. 18 A diagram illustrating an example of a hardware configuration of the work plan creation apparatus according to the embodiments 1 to 3.

### DESCRIPTION OF EMBODIMENT(S)

Embodiment are described hereinafter with reference to the appended drawings. The same sign is assigned to the same portion or a corresponding portion in each drawing. A repetitive description of the same portion or the corresponding portion is appropriately simplified or omitted.

### Embodiment 1

<1-1. Configuration>

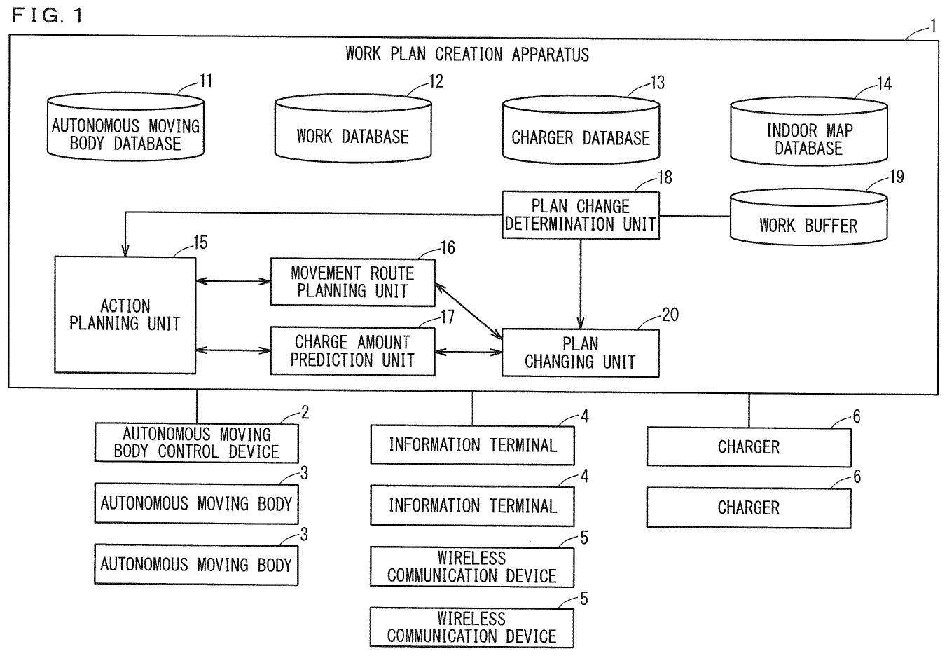

FIG. 1 is a configuration diagram of an autonomous moving body system to which a work plan creation apparatus 1 according to an embodiment 1 is applied.

As illustrated in FIG. 1, the autonomous moving body system includes a work plan creation apparatus 1, an autonomous moving body control device 2, an autonomous moving body 3, an information terminal 4, a wireless communication device 5, and a charger 6.

The plurality of information terminals 4 are carried by the plurality of persons, respectively, or disposed in a building. The information terminal 4 is a wearable device such as a smartphone or a guideboard disposed in a building, for example. FIG. 1 illustrates a case where two information terminals 4 are present, however, the configuration is not limited thereto, but it is sufficient that at least one information terminal 4 is present.

The plurality of autonomous moving bodies 3 are disposed in a specific region inside or outside a building. The autonomous moving body 3 is a device autonomously moved without an operation by a person. The autonomous moving body 3 is a robot or a personal mobility, for example. The autonomous moving body 3 may be a driverless taxi or a large transfer robot, for example. FIG. 1 illustrates a case where two autonomous moving bodies 3 are present, however, the configuration is not limited thereto, but it is sufficient that at least one autonomous moving body 3 is present.

The plurality of wireless communication devices 5 are disposed in the building. Each wireless communication device 5 can perform wireless communication with each information terminal 4. FIG. 1 illustrates a case where two wireless communication devices 5 are present, however, the configuration is not limited thereto, but it is sufficient that at least one wireless communication device 5 is present.

The autonomous moving body control device 2 is disposed in the building. The autonomous moving body control device 2 controls each autonomous moving body 3.

The work plan creation apparatus 1 includes an autonomous moving body database 11, a work database 12, a charger database 13, an indoor map database 14, an action planning unit 15, a movement route planning unit 16, a charge amount prediction unit 17, a plan change determination unit 18, a work buffer 19, and a plan changing unit 20.

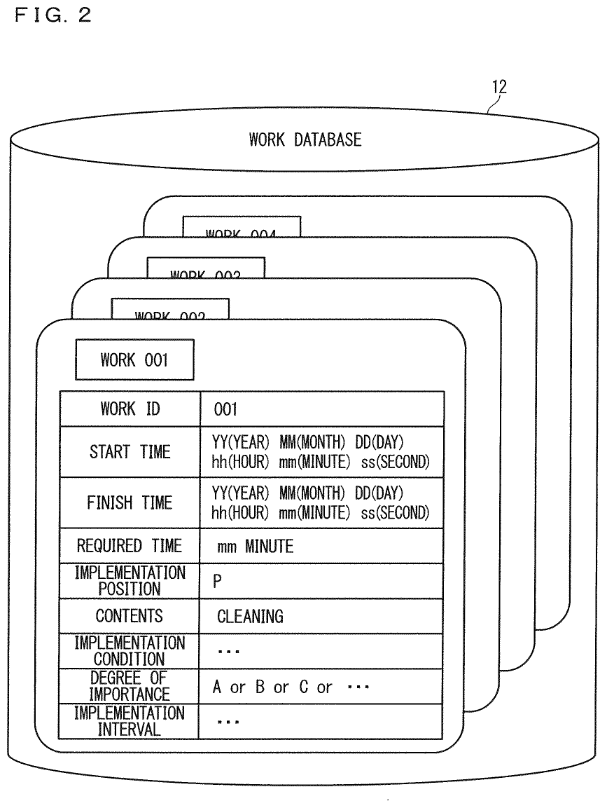

The work database 12 stores information regarding the work of the autonomous moving body 3. FIG. 2 is a diagram for explaining the work database 12. The work stored in the work database 12 indicates a job which a user of the work plan creation apparatus 1 requests the autonomous moving body 3 to perform. The user of the work plan creation apparatus 1 records the work requested to the autonomous moving body 3 in the work database 12.

For example, the work database 12 associates work information of each work with each other by a work ID and stores it. The work information includes at least contents of the work, an implementation position of the work, a start time and a finish time at which the work can be implemented. The work information may include a required time of the work, an implementation condition of the work, an implementation interval of the work, and a degree of importance of the work in comparison with the other work. In FIG. 2, “A or B or C or” is described as the degree of importance, however, one of them is actually described. For example, it is also applicable that a degree of importance A has a highest degree of importance, and the degree of importance decreases in an order of a degree of importance B, C . . . . For example, a work having a high degree of importance is preferentially allocated to an early time in a designated period of time. For example, charging and movement are works for the autonomous moving body 3, but are not recorded in the work database 12.

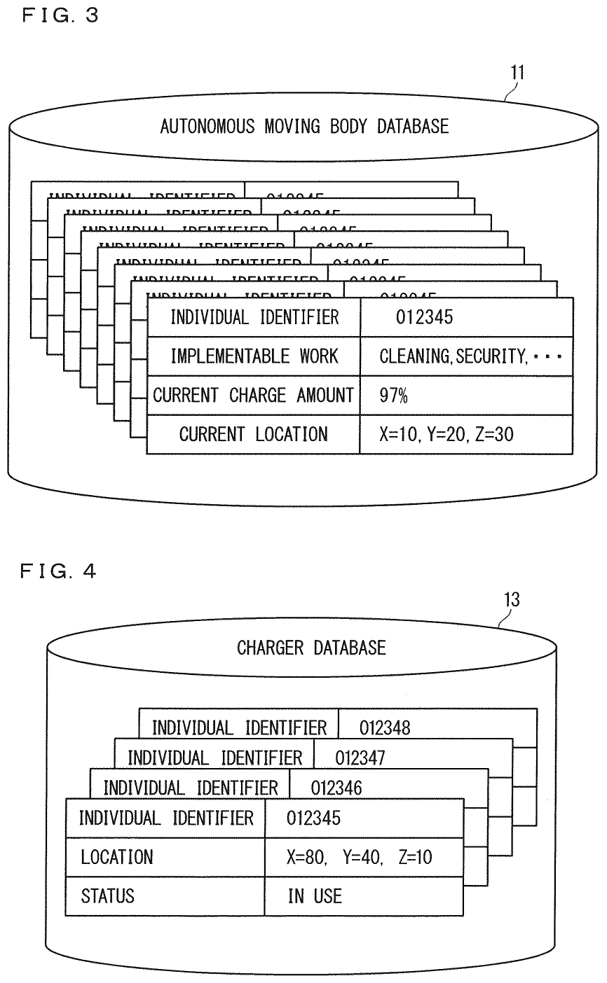

The autonomous moving body database 11 stores information regarding the autonomous moving body 3. FIG. 3 is a diagram for explaining the autonomous moving body database 11. The autonomous moving body database 11 associates an individual identifier of the autonomous moving body 3, an implementable work of the autonomous moving body 3, a current charge amount of the autonomous moving body 3, and a current location of the autonomous moving body 3 with each other and stores them.

The charger database 13 stores information regarding the charger 6 used for charging the autonomous moving body 3. FIG. 4 is a diagram for explaining the charger database 13. The charger database 13 associates an individual identifier of the charger 6, a location of the charger 6, and a status of the charger 6 with each other and stores them.

The indoor map database 14 stores information regarding a map in a building where the autonomous moving body 3 is disposed.

The charge amount prediction unit 17 predicts a charge amount of each autonomous moving body 3. For example, the charge amount prediction unit 17 predicts a temporal change of the charge amount of each autonomous moving body 3 based on information from the autonomous moving body control device 2. The information which the charge amount prediction unit 17 obtains from the autonomous moving body control device 2 includes a current charge amount of each autonomous moving body 3.

The movement route planning unit 16 creates a movement route of each autonomous moving body 3. For example, the movement route planning unit 16 creates a movement route for each autonomous moving body 3 from a start point to a destination point based on information from the autonomous moving body control device 2, information stored in the charger database 13, information stored in the autonomous moving body database 11, and information stored in the indoor map database 14.

The action planning unit 15 previously creates the work plan in which the work performed by each autonomous moving body 3 is allocated to a predetermined period (planning period). For example, the action planning unit 15 allocates the work to each autonomous moving body 3 so that the charge amount of each autonomous moving body 3 falls below a necessary amount in the period. Then, a start time and a finish time of the work of each autonomous moving body 3 and a start time and a finish time of the movement of each autonomous moving body 3 are determined. A planning period of the work plan is determined to be one day, several hours, or one week, for example. The action planning unit 15 creates the work plan (previous work plan) in a next planning period before the planning period of the work plan currently executed is finished. The previous work plan is created every ten minutes before the planning period, or created when a user of the work plan creation apparatus 1 requests to create the work plan before the planning period is started, for example.

The plan change determination unit 18 transmits a command of changing the work plan to the plan changing unit 20 upon receiving the new work. The new work indicates a work newly occurring in a period in which the autonomous moving body 3 performs the work plan. For example, a user of the information terminal 4 operates the information terminal 4, thereby requesting to perform the new work. Alternatively, necessity of the work is determined from information of a sensor or a camera provided to the autonomous moving body 3 or a building, and the work determined to be necessary is requested to be performed as the new work. In this case, the autonomous moving body control device 2 or the wireless communication device 5 which can communicate with a sensor or a camera provided to a building may determine the necessity of the work and request to perform the new work.

The plan changing unit 20 changes the work plan of the autonomous moving body 3. The plan changing unit 20 changes the work plan of the autonomous moving body 3 upon receiving a command of changing the work plan from the plan change determination unit 18, for example. The change of work plan indicates that the new work and a work on which the plan changing unit 20 determines that allocation needs to be reviewed in the works which have been already allocated to the autonomous moving body 3 are allocated to the autonomous moving body 3. Such a method of allocating the work to the autonomous moving body 3 is similar to the method of allocating the work by the action planning unit 15.

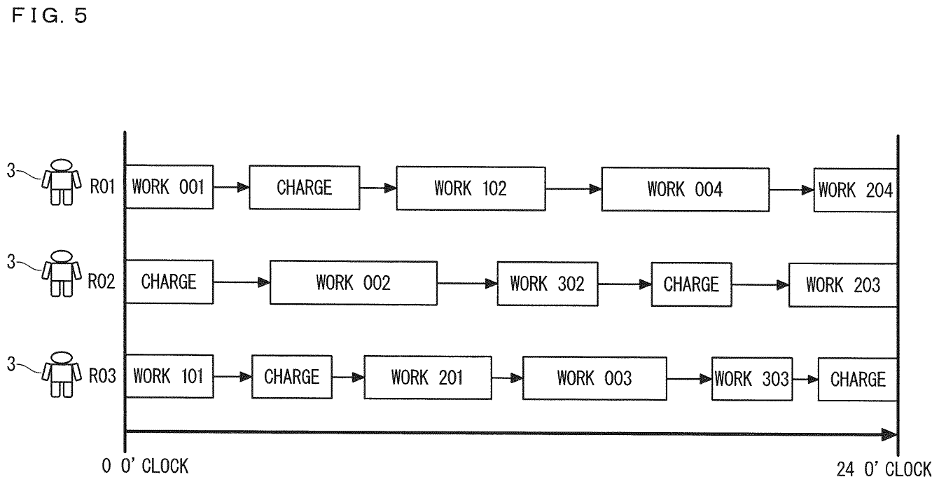

Herein, the work plan of the autonomous moving body 3 is described using FIG. 5.

As illustrated in FIG. 5, for example, the work plan creation apparatus 1 creates the work plan of each of the autonomous moving body 3 of “R01”, the autonomous moving body 3 of “R02”, and the autonomous moving body 3 of “R03”. Specifically, the work plan creation apparatus 1 creates the work plan including a date and a time of performing a plurality of works selected from the works stored in the work database 12 such as a work “001”, a work “002”, and a work “003” and a movement route to an implementation position of the work.

<1-2. Operation of Action Planning Unit>

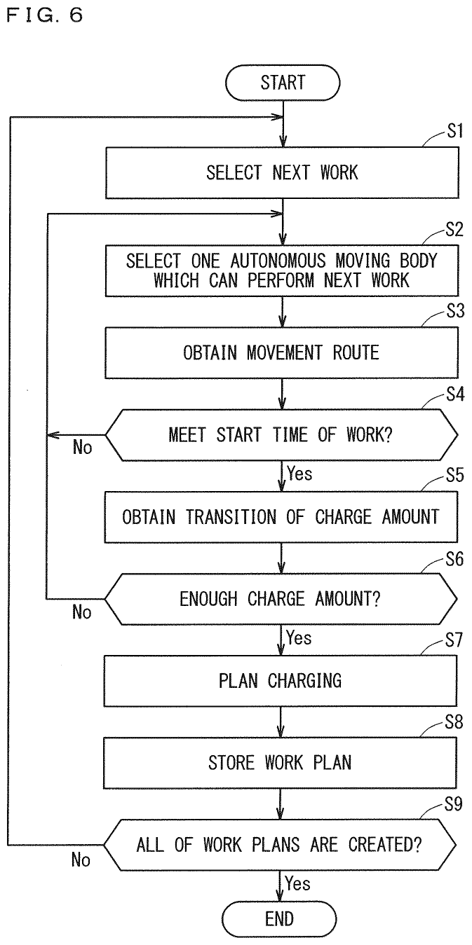

FIG. 6 is a flow chart illustrating an operation of the action planning unit 15, and illustrates an operation when the action planning unit 15 previously creates the work plan.

In Step S1, the action planning unit 15 selects a next work which is a work on which the allocation is determined next. The action planning unit 15 selects the next work by the following method, for example.
A work having an earliest start time is selected as the next work in the work database 12.
A work having an earliest finish time is selected as the next work in the work database 12.
A work in which a time after an elapse of a required time from starting of the work at a start time is closest is selected as the next work in the work database 12.
A work in which a time for ensuring a required time for finishing the work at a finish time is closest is selected as the next work in the work database 12.
A work having an implementation position closest to an implementation position of an immediately subsequent work or a shortest movement time for moving to an implementation position of an immediately subsequent work as the next work in the work database 12.
A work having a highest degree of importance is selected as the next work in the work database 12.
A work having a largest value of an evaluation function calculated from a degree of importance or a required time, for example, is selected as the next work in the work database 12.

In Step S2, the action planning unit 15 selects one autonomous moving body 3 which can perform the next work in the autonomous moving body database 11. For example, the action planning unit 15 selects the autonomous moving body 3 having no schedule of performing the work during the start time and the finish time of the next work. In the description hereinafter, the work performed immediately before the next work is referred to as an immediately preceding work, and the work performed immediately after the next work is referred to as an immediately subsequent work in the works already allocated to the work plan of the selected autonomous moving body 3.

In Step S3, the action planning unit 15 obtains the movement route of the autonomous moving body 3 selected in Step S2 from the movement route planning unit 16. Specifically, the movement route planning unit 16 determines a time at which the autonomous moving body 3 starts moving to the implementation position of the next work from the implementation position of the immediately preceding work. For example, when a period of time in which the movement in an area is suppressed is regulated such as a case where the area including the movement route is crowded during the finish time of the immediately preceding work and the start time of the next work, the movement route planning unit 16 determines the start time and the finish time of the movement of the autonomous moving body 3 so that the movement of the autonomous moving body 3 is completed in a period of time which does not include a period of time in which the movement in the area is suppressed. The movement route planning unit 16 also determines the movement route from the implementation position of the next work to the implementation position of the immediately subsequent work. The action planning unit 15 obtains the movement route determined by the movement route planning unit 16 in the manner described above.

In Step S4, the action planning unit 15 determines whether or not the autonomous moving body 3 meets the start time of the next work when the autonomous moving body 3 selected in Step S2 moves to the implementation position of the next work from the implementation position of the immediately preceding work by the movement route determined in Step S3. When the immediately subsequent work is already determined in the work plan of the autonomous moving body 3, the action planning unit 15 also determines whether or not the autonomous moving body 3 meets the start time of the immediately subsequent work when the autonomous moving body 3 moves to the implementation position of the immediately subsequent work from the implementation position of the next work.

When the autonomous moving body 3 does not meet the start time of the next work or the start time of the immediately subsequent work in Step S4, the process returns to Step S2. In the meanwhile, when the autonomous moving body 3 meets the start time of the next work or the start time of the immediately subsequent work in Step S4, the process proceeds to Step S5.

In Step S5, the action planning unit 15 obtains a prediction result of a temporal change of a charge amount of the autonomous moving body 3 from the charge amount prediction unit 17.

In Step S6, the action planning unit 15 determines whether or not the charge amount of the autonomous moving body 3 selected in Step S2 is sufficient in an optional time in a planning period. For example, the action planning unit 15 determines whether or not the charge amount of the autonomous moving body 3 satisfies a remaining amount necessary to move to a position where the charger 6 is disposed after performing the next work. The charge amount necessary for the autonomous moving body 3 to perform the work can be learned from a past record of a power consumption amount in performing the work, for example. The charge amount necessary for the movement between the works can be learned from a past record of a past movement, for example.

When it is determined that the charge amount of the autonomous moving body 3 is not sufficient in Step S6, the process returns to Step S2. In the meanwhile, when it is determined that the charge amount of the autonomous moving body 3 is sufficient in Step S6, the process proceeds to Step S7.

In Step S7, the action planning unit 15 plans the charge of the autonomous moving body 3 selected in Step S2.

In Step S8, the action planning unit 15 stores the next work designed before, the movement to the implementation position of the next work, and the schedule of the charge as the work plan of the autonomous moving body 3 selected in Step S2.

In Step S9, the action planning unit 15 determines whether or not the work plan of the autonomous moving body 3 has been created for all the works stored in the work database 12. When it is determined that the work plan of the autonomous moving body 3 is not created for all the works in Step S9, the process returns to Step S1. In the meanwhile, when it is determined that the work plan of the autonomous moving body 3 is created for all the works in Step S9, the operation illustrated in FIG. 6 is finished. Also applicable in Step S9 as a determination condition is whether the work plan is created to include the number of works which has been previously set from the work database 12 or whether the work plan is created to include all the works which should be performed in a next planning period, for example.

<1-3. Operation of Plan Change Determination Unit>

The plan change determination unit 18 transmits a command of changing the work plan to the plan changing unit 20 upon receiving the new work. Specifically, the plan change determination unit 18 calculates an evaluation function value of the new work upon receiving the new work. The evaluation function is to measure a degree of priority of the new work, and can be calculated from a start time, a finish time, a required time, and a degree of importance of the new work, for example. For example, an evaluation function f_{c} (x) of a new work x is expressed by the following expression (1).

$$\begin{matrix}[ Expression 1 ] & \\ {f}_{c} ( x ) = \frac{α \times {T}_{req}}{{( {T}_{st} + {T}_{en} - 2 {T}_{now} )}^{k}} & ( 1 )\end{matrix}$$

In the expression (1), T_{now} is a time of receiving the new work x. Tₛₜ is a start time of the new work x. Tₑₙ is a finish time of the new work x. T_{req} is a required time of the new work x. α is a degree of importance of the new work x. k is a parameter and is an integral number equal to or larger 1.

An evaluation function value of the evaluation function f_{c} (x) increases as the start time Tₛₜ and the finish time Tₑₙ of the new work x are close to the time T_{now}. The evaluation function value increases also when the degree of importance α is high or the require time T_{reg} is long. When the start of the next planning period comes soon, the new work can be allocated when the action planning unit 15 creates the next work plan, thus when the time elapsing before creating the next work plan is short, a term may be added to reduce the evaluation function value.

Next, the plan change determination unit 18 determines whether or not to transmit a command of changing the work plan to the plan changing unit 20 in accordance with the evaluation function value of the new work. For example, the plan change determination unit 18 classifies the degree of priority of the new work into three levels in accordance with the evaluation function value, and determines that a maximum is level 3 and minimum is level 1.

When the plan change determination unit 18 determines that the degree of priority of the new work is level 3, the plan change determination unit 18 transmits a request of changing the work plan and work information of the new work to the plan changing unit 20.

When the plan change determination unit 18 determines that the degree of priority of the new work is level 2, the plan change determination unit 18 stores work information of the new work in the work buffer 19. When the number of the accumulated works having the degree of priority of level 2 is to be equal to or larger than a predetermined number, the plan change determination unit 18 transmits the work information stored in the work buffer 19 to the action planning unit 15.

When the plan change determination unit 18 determines that the degree of priority of the new work is level 1, the plan change determination unit 18 stores work information of the new work in the work buffer 19. When the action planning unit 15 creates the next work plan, the plan change determination unit 18 transmits the work information stored in the work buffer 19 to the action planning unit 15.

The work buffer 19 may be integrally foamed with the work database 12. In this case, a flag may be provided to a work which is originally included in the work database 12 to distinguish the work which is originally included in the work database 12 and the new work obtained by the plan change determination unit 18.

<1-4. Operation of Plan Changing Unit>

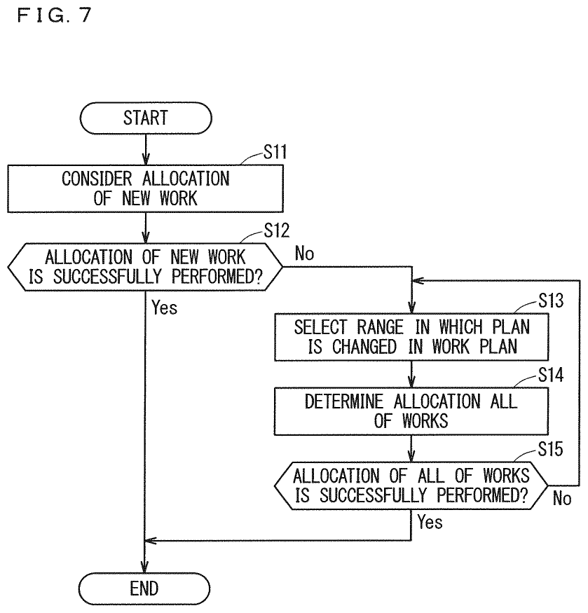

FIG. 7 is a flow chart illustrating an operation of the plan changing unit 20, and illustrates an operation when the plan changing unit 20 changes the work plan. The plan changing unit 20 changes the work plan when the plan change determination unit 18 requests the change of the work plan from the plan change determination unit 18.

In Step S11, the plan changing unit 20 examines the allocation of the new work transmitted from the plan change determination unit 18. A method of allocating the new work to the work plan is based on the operation of the action planning unit 15 illustrated in FIG. 6, thus the description thereof is omitted herein.

In Step S12, the plan changing unit 20 determines whether or not the allocation of the new work is successfully performed. When the allocation of the new work is successfully performed, the operation illustrated in FIG. 7 is finished. In the meanwhile, when the allocation of the new work is not successfully performed, the process proceeds to Step S13.

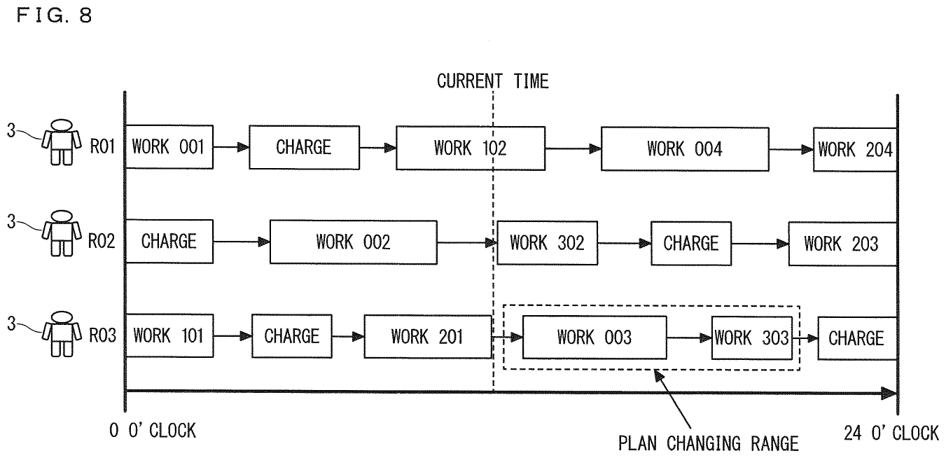

In Step S13, the plan changing unit 20 selects a range in which the plan is changed in an existing work plan created for the autonomous moving body 3. The work included in the range in which the plan is changed is a work which has been already allocated to the work plan of the autonomous moving body 3 having a plan to be changed. The autonomous moving body 3 having the plan to be changed has a capacity of performing the new work, and all of the autonomous moving bodies 3 currently performing the work plan may be a target having the plan to be changed, for example. The work having a plan to be changed may be all of the works after a point of time of changing the plan or the work scheduled to be performed within an hour from a point of time of changing the plan. In the example in FIG. 8, the work “003” and the work “303” in the work plan of the autonomous moving body 3 of “R03” are the range in which the plan selected by the plan changing unit 20 is changed in Step S13 (plan changing range).

In Step S14, the plan changing unit 20 determines the allocation of all the works for the new work transmitted from the plan change determination unit 18 and the work included in the range in which the plan selected in Step S13 is changed. The process in Step S14 is based on the operation of the action planning unit 15 illustrated in FIG. 6, thus the description is omitted herein.

In Step S15, the plan changing unit 20 determines whether or not the allocation of all of the works is successfully performed in Step S14. When the allocation of all of the works is successfully performed in Step S15, the operation illustrated in FIG. 7 is finished. In the meanwhile, when it is determined that the allocation of all of the works is not successfully performed in Step S15, the process returns to Step S13.

As described above, in Step S11, the allocation of the new work is examined without changing the work in which the allocation has been already determined, thus an unnecessary change of the allocation of the work can be prevented.

When the plan changing range is selected in Step S13, a part of the work of a specific one autonomous moving body 3 is selected as the changing range firstly, for example, and subsequently the changing range is increased again in Step S13 in a case where all of the desired works cannot be allocated, thus the changing range can be kept small. At this time, as a method of selecting the changing range firstly, the work allocated to the autonomous moving body 3 having a longest standby time may be selected as the changing range in a period of time in which the added new work can be performed. The work included in the changing range in the autonomous moving body 3 is selected so that a sum of the implementation time of the work to be changed exceeds an implementation time of the new work, for example.

<1-5. Effect>

As described above, the work plan creation apparatus 1 according to the embodiment 1 determines whether or not to change the work plan based on the work information of the new work when the new work occurs during performing the work plan of the autonomous moving body 3, and automatically changes the work plan when the work plan needs to be changed. Accordingly, the autonomous moving body 3 can be made to perform the work without delay when the work needs to be adjusted.

A risk of reduction of efficiency of the work plan by changing the work plan can be reduced to a minimum.

### Embodiment 2

Described in the embodiment 1 is the case where the work plan is changed when the work (the new work) which is not included in the previous work plan occurs. Described in the embodiment 2 is a case where the work plan cannot be performed due to occurrence of an accident in the autonomous moving body 3 such as a breakdown of the autonomous moving body 3, for example.

<2-1. Configuration>

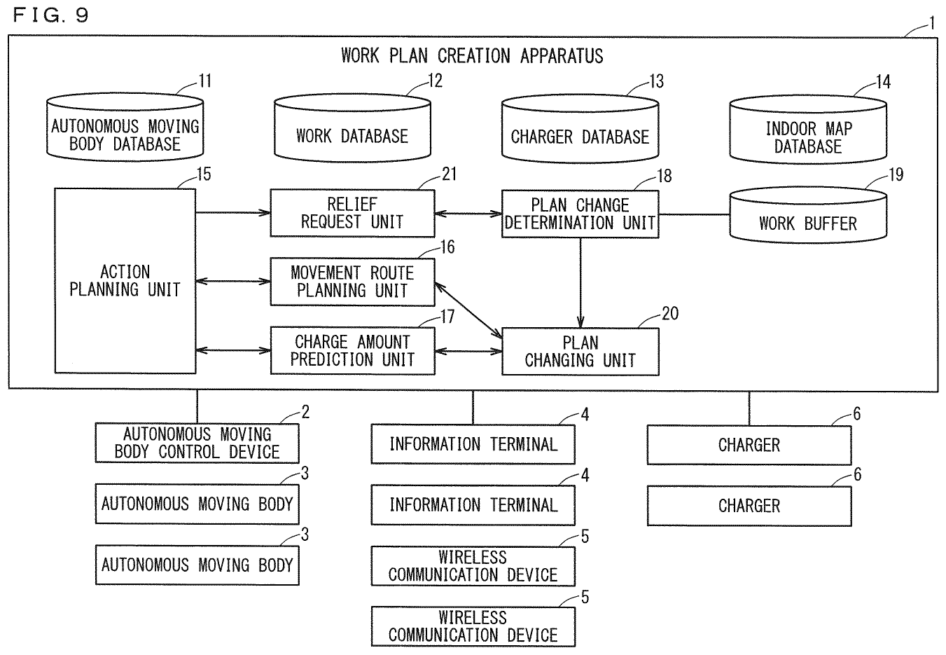

FIG. 9 is a configuration diagram of an autonomous moving body system to which the work plan creation apparatus 1 according to an embodiment 2 is applied. The work plan creation apparatus 1 according to the embodiment 2 has a feature that it includes a relief request unit 21. The other configuration is similar to the work plan creation apparatus 1 (refer to FIG. 1) according to the embodiment 1, thus the detailed description is omitted here.

When disturbance occurs in the work plan while the autonomous moving body 3 performs the work plan, the relief request unit 21 generates a relief work to appropriately deal with the disturbance, and requests the plan changing unit 20 to change the work plan. Examples of the occurrence of the disturbance in the work plan include a case where the autonomous moving body 3 cannot complete the work by a scheduled finish time or a case where the autonomous moving body 3 cannot move to the implementation position of the work by a start time. That is to say, the relief request unit 21 notifies the plan changing unit 20 of a failed work as a relief work when the autonomous moving body 3 fails to perform the work.

A method of detecting disturbance of the work plan performed by the relief request unit 21 includes a method of transmitting a work failure notification from the autonomous moving body 3 to the relief request unit 21 when the autonomous moving body 3 fails to perform the work. The method thereof includes the other method such as a method that the autonomous moving body 3 transmits a work completion notification to the relief request unit 21 every time the work allocated in the work plan is completed and the relief request unit 21 determines that a work whose work completion notification does not reach by a scheduled finish time is a work which the autonomous moving body 3 fails to perform.

<2-2. Operation of Relief Request Unit>

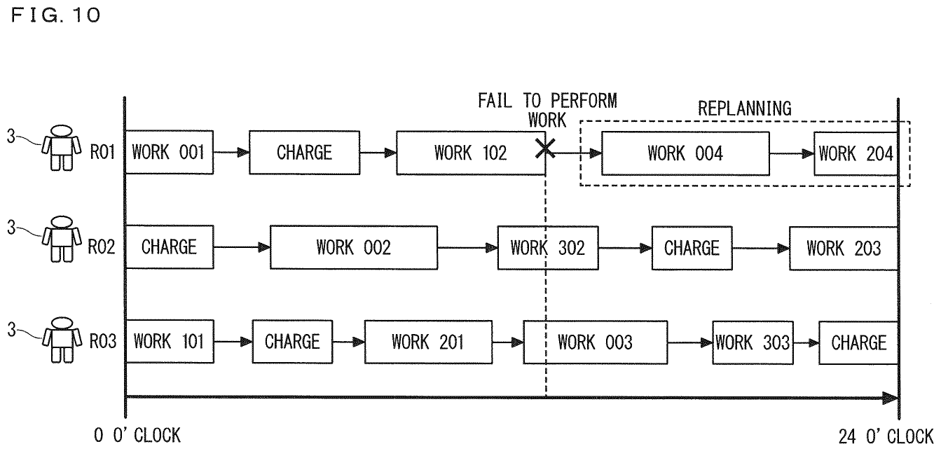

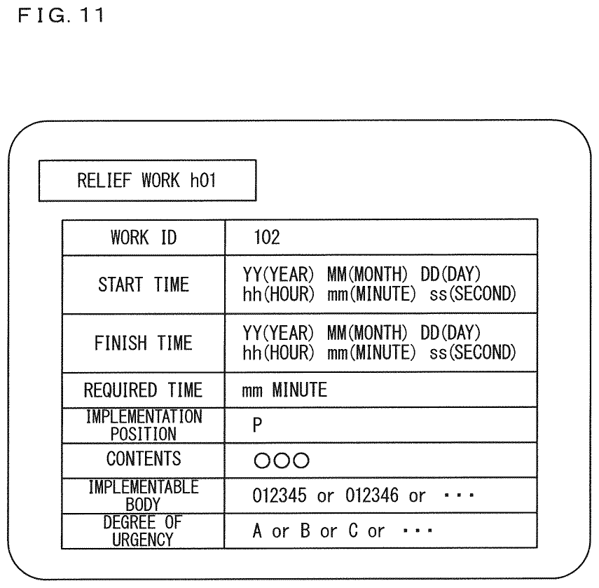

An operation of the relief request unit 21 is described using FIGS. 10 and 11.

When the relief request unit 21 receives the work failure notification of a certain work from the autonomous moving body 3 or determines that the autonomous moving body 3 fails to perform a certain work, the relief request unit 21 generates a relief work. When the autonomous moving body 3 fails to perform the work, the relief request unit 21 needs to review a subsequent work plan of the autonomous moving body 3, thus the relief request unit 21 releases the work plan subsequent to the failed work, and considers the released work as the new work and transmits the work information to the plan change determination unit 18 together with the relief work, thereby requesting the change of the work plan. A range of the work plan released at this time may be all the works subsequent to the failed work in a planning period, or may also be a part of the immediate work on which the failure of the work is considered to have influence, for example.

For example, it is assumed that the autonomous moving body 3 of “R01” fails to perform the work “102” in FIG. 10. At this time, the relief request unit 21 wholly reviews the work plan subsequent to the failed work “102”, and the work “004” and the work “204” are transmitted to the plan change determination unit 18 as the new work. When the relief request unit 21 releases only a part of the work, the relief request unit 21 estimates a movement time in the movement route planning unit 16, and determines whether or not the autonomous moving body 3 meets the start time of the work which is immediately performed.

The relief work is a work in which the work which the autonomous moving body 3 has failed to perform is continuously performed by the autonomous moving body 3 or performed by the other autonomous moving body 3. For example, as illustrated in FIG. 11, the relief work includes a start time, a finish time, an implementation position, and a required time, and further includes an implementable body and a degree of urgency.

The implementable body indicates the autonomous moving body 3 which can or should perform the relief work. For example, when the autonomous moving body 3 does not finish a certain work on time, only such an autonomous moving body 3 is set as the implementable body so as to request such an autonomous moving body 3 to continuously perform the work. In the meanwhile, when the autonomous moving body 3 fails to perform a certain work due to a breakdown of the autonomous moving body 3, for example, the relief request unit 21 determines that it is difficult to such an autonomous moving body 3 to continuously perform the work, and sets the other autonomous moving body 3 other than such an autonomous moving body 3 as the implementable body.

The degree of urgency of the relief work indicates urgency of the relief work. The degree of urgency is classified into three stages, for example. In this case, when the degree of urgency is maximum, the relief request unit 21 requests immediate implementation after reviewing the work plan in the plan changing unit 20. When the degree of urgency is a medium degree, the relief request unit 21 requests implementation in one hour after changing the work plan. When the degree of urgency is minimum, the relief request unit 21 requests implementation in a certain point of time in the planning period of the work plan which is currently performed. In FIG. 11, “A or B or C or . . . ” is indicated as the degree of urgency, however, one of them is actually indicated. For example, it is also applicable that a degree of urgency A has a highest degree of urgency, and the degree of urgency decreases in an order of a degree of urgency B, C

<2-3. Operation of Plan Change Determination Unit>

Described is an operation of the plan change determination unit 18 in a case of receiving the work information of the relief work from the relief request unit 21.

The work information transmitted from the relief request unit 21 includes the work information of the relief work and the work information of the work released from the work plan. The plan change determination unit 18 determines whether or not to transmit a command of changing the work plan to the plan changing unit 20 as described in the embodiment 1 for all of these works.

However, in the embodiment 2, it is clear that a failure of some work occurs and disturbance occurs in the work plan of some autonomous moving body 3, thus requested to the plan changing unit 20 is change of the work plan regardless of the evaluation function value of the work information. At this time, the work information transmitted to the plan changing unit 20 may be the work information of all of the works stored in the work buffer 19, the work information of some work stored in the work buffer 19, or the work information of only the work transmitted from the relief request unit 21.

<2-4. Operation of Plan Changing Unit>

The plan changing unit 20 changes the work plan of the autonomous moving body 3 upon receiving a command of changing the work plan from the plan change determination unit 18. At this time, the plan changing unit 20 changes the work plan based on the degree of urgency of the relief work with regard to the relief work. The method of allocating the work to the autonomous moving body 3 is similar to the method of allocating the work by the action planning unit 15.

<2-5. Effect>

As described above, when a certain autonomous moving body 3 cannot complete the work in accordance with the work plan due to a breakdown, for example, the work plan creation apparatus 1 according to the embodiment 2 automatically changes the work plan in consideration of the degree of urgency of the work which cannot be completed. Accordingly, the autonomous moving body 3 can be made to perform the work without delay when the work needs to be adjusted.

### Embodiment 3

Described in the embodiment 1 is the case where the work plan is changed in accordance with the degree of priority of the new work when the new work occurs. Described in an embodiment 3 is a case where allocation of a work occurring in accordance with a prediction is simplified by predicting a work occurring during performing the work plan.

<3-1. Configuration>

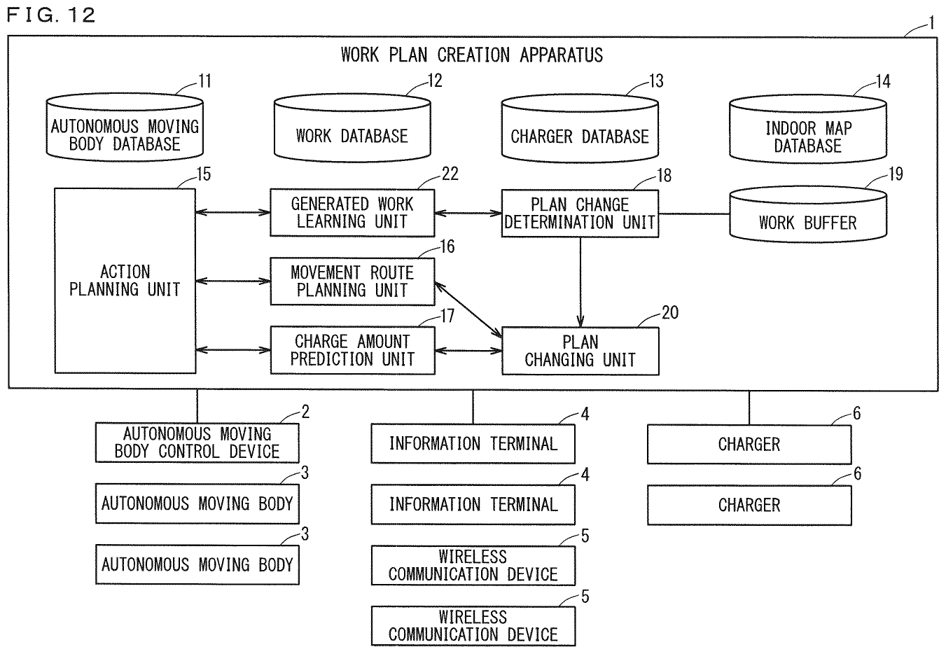

FIG. 12 is a configuration diagram of an autonomous moving body system to which the work plan creation apparatus 1 according to the embodiment 3 is applied. The work plan creation apparatus 1 according to the embodiment 3 has a feature that it includes a generated work learning unit 22. The other configuration is similar to the work plan creation apparatus 1 (refer to FIG. 1) according to the embodiment 1, thus the detailed description is omitted here.

The generated work learning unit 22 receives the work information of the new work from the plan change determination unit 18 every time the new work occurs in the planning period of the work plan. Then, the generated work learning unit 22 stores and learns the work information of the new work received in each planning period, and calculates a probability of occurrence of the new work received in each period of time or for each of contents of the work.

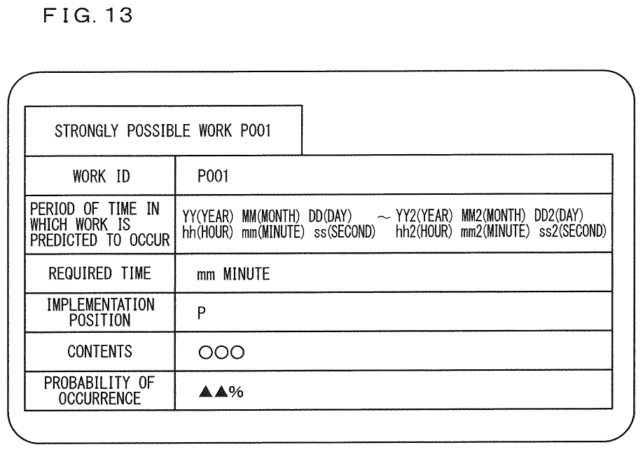

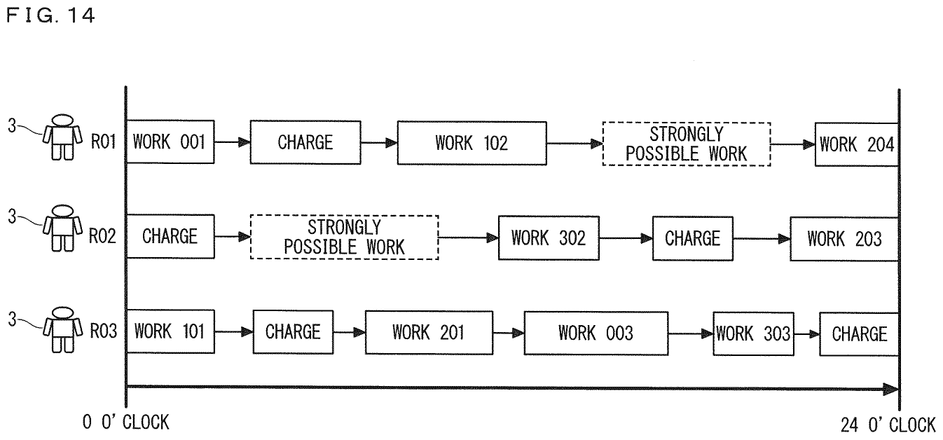

A work having a probability of occurrence during performing the work plan is determined to be a % or more is stored in the work database 12 as a strongly possible work as illustrated in FIG. 13 from a learning result of the generated work learning unit 22. The strongly possible work stored in the work database 12 is allocated in creating the next work plan as illustrated in FIG. 14.

Subsequently, when the new work is included in the strongly possible work in a case where the new work occurs during performing the work plan, the strongly possible work is replaced with the new work in Step S11 in FIG. 7 to allocate the strongly possible work to the work plan. When the new work is not included in the strongly possible work, the new work is allocated to the work plan by a procedure described in the embodiment 1.

It is also applicable that the strongly possible work is not a specific work, however, a plurality of continuous works occurring with a high rate is the strongly possible work.

<3-2. Operation in Case where Prediction is Missed>

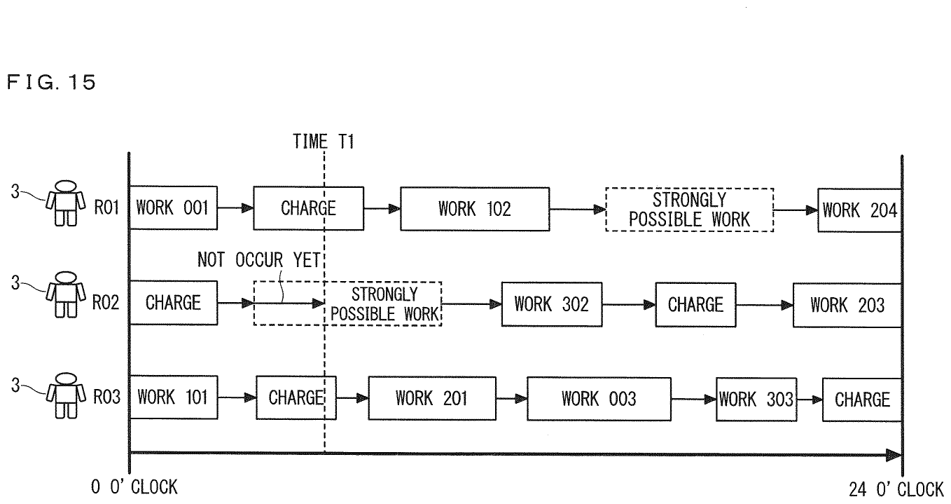

An operation in a case where the prediction of occurrence of the new work is missed is described using FIG. 15. Described as illustrated in FIG. 15 is a case where the strongly possible work allocated to the work plan of the autonomous moving body 3 of “R02” does not occur yet at a time Tl.

When the work allocated to the work plan of the autonomous moving body 3 as the strongly possible work does not actually occur, the autonomous moving body 3 does not perform the operation in a period of time corresponding to a period of the implementation time of the strongly possible work. Accordingly, there is a possibility that a final work efficiency is reduced.

Thus, when the predicted work (strongly possible work) does not occur, the plan changing unit 20 automatically changes the work plan. Applicable as a condition for changing the work plan is a condition that a certain strongly possible work does not occur yet even after 50% of a predicted period passes. Also applicable is a condition that the number of works occurring in a period of time in which the strongly possible work is predicted to occur is half or less of the predicted number thereof when the strongly possible work includes the plurality of works.

<3-3. Operation when Work Plan is Changed>

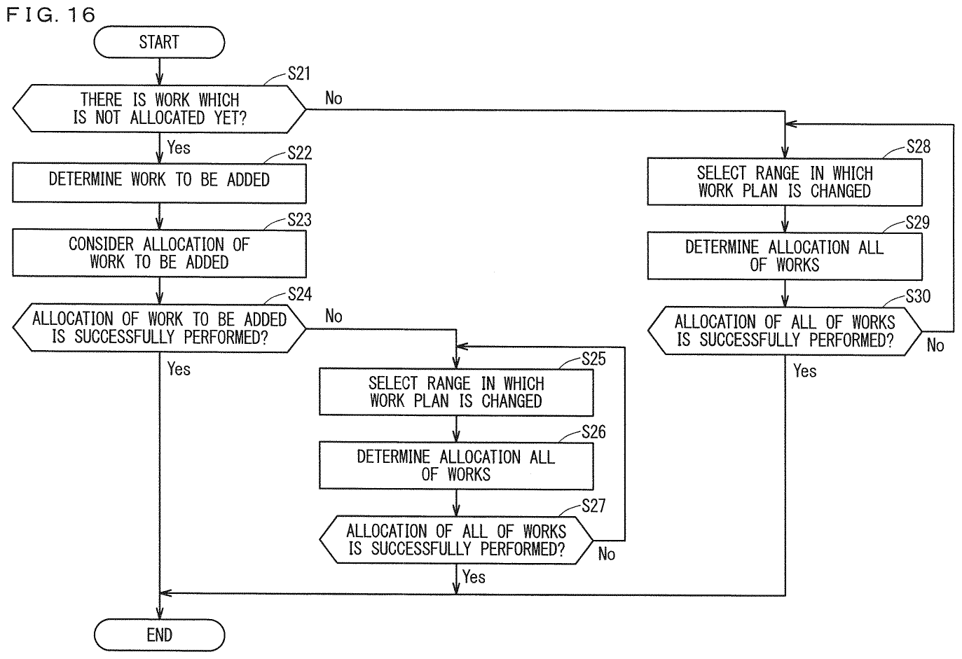

FIG. 16 is a flow chart illustrating an operation of the work plan creation apparatus 1 according to the embodiment 3, and illustrates an operation of changing the work plan. The change of work plan illustrated in FIG. 16 is performed when the condition for changing the work plan described above is established. The condition for changing the work plan is preset.

In Step S21, the plan changing unit 20 determines whether or not there is a work which is not allocated yet in the work database 12 or the work buffer 19 in changing the work plan. The work which is not allocated yet indicates a work which is not allocated to any autonomous moving body 3 in the work plan which is currently performed.

When it is determined in Step S21 that there is no work which is not allocated yet in the work database 12 or the work buffer 19, the process proceeds to Step S28. In the meanwhile, when it is determined in Step S21 that there is a work which is not allocated yet in the work database 12 or the work buffer 19, the process proceeds to Step S22.

In Step S22, the plan changing unit 20 determines a work to be added. For example, the plan changing unit 20 selects N works (N indicates the number of works) in decreasing order of evaluation function calculated in the plan change determination unit 18 in the works stored in the work buffer 19. Alternatively, the plan changing unit 20 newly calculates an evaluation function value from selects N works from a start time, a finish time, a required time, and a degree of importance of each work, for example, for all of the works which are not allocated yet, and selects N works in decreasing order of the evaluation function value. The number of works selected in Step S22 may be previously set by an administrator, or may also be calculated by a standby time of the autonomous moving body 3 performing the work plan, for example. The work to be added may be determined not by the number of works but by a total sum of an implementation time of the selected works.

An operation of Step S23 to Step S27 is similar to that of Step S11 to Step S15 when “the new work” in Step S11 and Step S12 in FIG. 7 is replaced with “the work to be added”, thus the description is omitted herein.

When it is determined in Step S21 that there is no work which is not allocated yet in the work database 12 or the work buffer 19, the work is not newly allocated to the work plan. Examples of the change of the plan performed at this time include a case of advancing the implementation of the work which is to be performed subsequently or a case of performing works at intervals to leave time in the movement of the autonomous moving body 3. A specific operation in Step S28 to Step S30 is similar to the operation in Step S13 to Step S15 in FIG. 7, thus the description is omitted herein.

<3-4. Effect>

As described above, the work plan creation apparatus 1 according to the embodiment 3 predicts the strongly possible work occurring in the planning period from past data, and previously creates the work plan in consideration of the strongly possible work. Accordingly, in the case where the new work occurs in the planning period, when the new work is included in the strongly possible work, the change of the work plan can be reduced to a minimum.

When the number of new works occurring in the planning period falls below the prediction, reduction of efficiency of the work plan can be prevented by automatically reviewing the work plan.

<Hardware Configuration>

Each function of the action planning unit 15, the movement route planning unit 16, the charge amount prediction unit 17, the plan change determination unit 18, and the plan changing unit 20 in the work plan creation apparatus 1 described in the embodiment 1 is achieved by a processing circuit. That is to say, the work plan creation apparatus 1 includes a processing circuit for previously creating the work plan of each autonomous moving body 3 in the predetermined period, creating the movement route of each autonomous moving body 3, predicting the charge amount of each autonomous moving body 3, determining whether or not to change the work plan in accordance with the degree of priority of the new work, and changing the work plan of the autonomous moving body 3. The processing circuit may be dedicated hardware, or may also be a processor (also referred to as a central processing unit (CPU), a processing device, an arithmetic device, a microprocessor, a microcomputer, or a digital signal processor (DSP)) for executing a program stored in a memory.

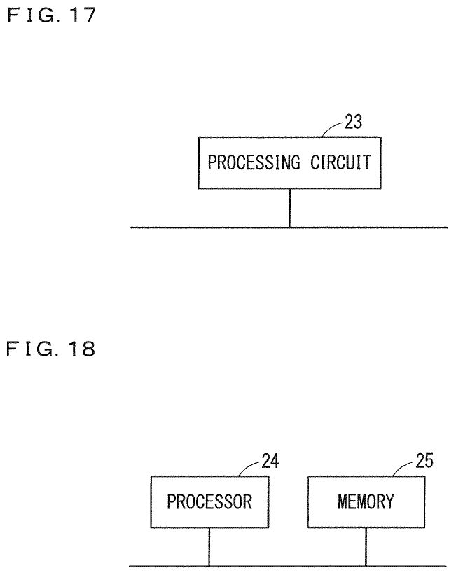

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 23 as illustrated in FIG. 17. Each function of the action planning unit 15, the movement route planning unit 16, the charge amount prediction unit 17, the plan change determination unit 18, and the plan changing unit 20 may be achieved by the processing circuit 23, or functions of them may be collectively achieved by one processing circuit 23.

When the processing circuit 23 is a processor 24 illustrated in FIG. 18, each function of the action planning unit 15, the movement route planning unit 16, the charge amount prediction unit 17, the plan change determination unit 18, and the plan changing unit 20 is achieved by software, firmware, or a combination of software and firmware. The software or the firmware is described as a program and is stored in a memory 25. The processor 24 reads out and executes a program stored in the memory 25, thereby achieving each function. That is to say, the work plan creation apparatus 1 includes the memory 25 storing programs which consequently execute a step of previously creating the work plan of each autonomous moving body 3 in the predetermined period, creating the movement route of each autonomous moving body 3, predicting the charge amount of each autonomous moving body 3, determining whether or not to change the work plan in accordance with the degree of priority of the new work, and changing the work plan of the autonomous moving body 3. These programs are also deemed to make a computer execute a procedure or a method of the action planning unit 15, the movement route planning unit 16, the charge amount prediction unit 17, the plan change determination unit 18, and the plan changing unit 20. Herein, a memory may be a non-volatile or volatile semiconductor memory such as a Random Access Memory (RAM), a Read Only Memory (ROM), a flash memory, an Electrically Programmable Read Only Memory (EPROM), or an Electrically Erasable Programmable Read Only Memory (EEPROM), a magnetic disc, a flexible disc, an optical disc, a compact disc, a Digital Versatile Disc (DVD), or any storage medium which is to be used in the future.

It is also applicable that some of the function of the action planning unit 15, the movement route planning unit 16, the charge amount prediction unit 17, the plan change determination unit 18, and the plan changing unit 20 are achieved by dedicated hardware, and other functions are achieved by software or firmware.

As described above, the processing circuit can achieve each function described above by the hardware, the software, or the combination of them, for example.

The hardware configuration of the work plan creation apparatus 1 (refer to FIG. 1) described in the embodiment 1 is described above, however, the same applies to the hardware configuration of the work plan creation apparatus 1 (refer to FIG. 9) described in the embodiment 2, and the hardware configuration of the work plan creation apparatus 1 (refer to FIG. 12) described in the embodiment 3.

Each embodiment can be arbitrarily combined, or each embodiment can be appropriately varied or omitted within the scope of the disclosure.

Although the present disclosure is described in detail, the foregoing description is in all aspects illustrative and does not restrict the disclosure. It is therefore understood that numerous modification examples not illustrated can be devised.

### EXPLANATION OF REFERENCE SIGNS

1 work plan creation apparatus, 2 autonomous moving body control device, 3 autonomous moving body, 4 information terminal, 5 wireless communication device, 6 charger, 11 autonomous moving body database, 12 work database, 13 charger database, 14 indoor map database, 15 action planning unit, 16 movement route planning unit, 17 charge amount prediction unit, 18 plan change determination unit, 19 work buffer, 20 plan 5 changing unit, 21 relief request unit, 22 generated work learning unit, 23 processing circuit, 24 processor, 25 memory.

1. A work plan creation apparatus, comprising:
a processor to execute a program, and
a memory to store the program which, when executed by the processor, performs processes of,
previously creating a work plan in which a work to be performed by at least one autonomous moving body is allocated in a predetermined period;
evaluating a degree of priority of a new work, which is a work newly occurring, upon receiving the new work, and determining whether or not to add the new work to the work plan in accordance with the degree of priority while the autonomous moving body performs the work plan;
when determining to add the new work, adding the new work to the work plan while the autonomous moving body performs the work plan to change the work plan; and
determining to add the new work to the work plan only when the degree of priority is high.

2. The work plan creation apparatus according to claim 1, wherein
evaluating the degree of priority includes evaluating the degree of priority based on an implementation period of the new work.

3. The work plan creation apparatus according to claim 1, wherein
evaluating the degree of priority includes evaluating the degree of priority based on a degree of importance of the work.

4. The work plan creation apparatus according to claim 1, wherein
changing the work plan includes determining a range of changing the work plan based on work information of the new work.

5. The work plan creation apparatus according to claim 1, comprising
determining whether or not the autonomous moving body can continuously perform a failed work when the autonomous moving body fails to perform a work, and when determining that the autonomous moving body cannot continuously perform the failed work, notifying the failed work as a relief work for requesting another autonomous moving body to perform an assist, wherein
changing the work plan includes changing c plan to include the relief work.

6. The work plan creation apparatus according to claim 1, comprising
learning a total number of the new work occurring in the period of the work plan or a period of time in which the new work is performed, wherein
creating the work plan includes creating the work plan including at least one strongly possible work which is a work predicted to occur in the period based on the learning result.

7. The work plan creation apparatus according to claim 6, wherein
changing the work plan includes changing the work plan when the strongly possible work does not occur in a certain period of time or a certain number of the strongly possible works or more do not occur while the work plan is performed.

8. (canceled)

9. The work plan creation apparatus according to claim 1, wherein
when determining that the degree of priority is low and the new work is not added, adding the new work to the work plan when creating a next work plan.

10. A work plan creation method, comprising:
previously creating a work plan in which a work to be performed by at least one autonomous moving body is allocated in a predetermined period;
evaluating a degree of priority of a new work, which is a work newly occurring, upon receiving the new work, and determining whether or not to add the new work to the work plan in accordance with the degree of priority while the autonomous moving body performs the work plan;
when determining to add the new work, adding the new work to the work plan while the autonomous moving body performs the work plan to change the work plan; and
determining to add the new work to the work plan only when the degree of priority is high.
